(19) United States
(12) Patent Application Publication
(10) Pub. No.: US 2024/0282505 A1
(43) Pub. Date: Aug. 22, 2024

(54) COIL DEVICE

(71) Applicant: TDK CORPORATION, Tokyo (JP)

(72) Inventors: Toshiyuki Horikawa, Tokyo (JP); Shinichiro Kokubo, Tokyo (JP)

(73) Assignee: TDK CORPORATION, Tokyo (JP)

(21) Appl. No.: 18/581,601

(22) Filed: Feb. 20, 2024

(30) Foreign Application Priority Data
Feb. 22, 2023 (JP) 2023-026411

(51) Int. Cl. H01F 27/26; H01F 27/10; H01F 27/22; H01F 27/32

(52) U.S. Cl. CPC H01F 27/263; H01F 27/105; H01F 27/22; H01F 27/325

(57) ABSTRACT

A coil device comprises a coil; a bobbin provided with the coil; a first core and a second core attached to the bobbin so as to face each other; and a first heat-dissipating plate attached to the first core. The first core comprises a first base portion and a first outer leg portion protruding from the first base portion and facing the second core with a gap therebetween. The gap has a gap side portion between a first side surface of the first outer leg portion and a second side surface of the second core. The first heat-dissipating plate covers at least the first base portion or the first outer leg portion so that the gap side portion is at least partly free.

### TECHNICAL FIELD

The present invention relates to a coil device.

### BACKGROUND

As described in Patent Document 1, a coil device used as a transformer or the like may include a radiator plate as a means for improving heat radiation properties. In the coil device of Patent Document 1, the radiator plate is attached to a first core and a second core (E-shaped cores), which are attached to a bobbin so as to face each other, so that the radiator plate covers the first core and the second core.

Incidentally, in terms of adjusting inductance or preventing magnetic saturation, a gap may be provided between a first outer leg portion of the first core and a second outer leg portion of the second core. It is found that, in this situation, attaching the radiator plate to the first core and the second core so as to cover the first core and the second core increases loss of the coil device to reduce efficiency of the coil device.
Patent Document 1: JP Patent Application Laid Open No. 2014-036194

### SUMMARY

The present invention has been achieved in view of such circumstances. It is an object of the invention to provide a coil device that has excellent heat-dissipation ability and can reduce loss when a gap is provided between a first core and a second core.

To achieve the above object, a coil device according to the present invention comprises:
a coil;
a bobbin provided with the coil;
a first core and a second core attached to the bobbin so as to face each other; and
a first heat-dissipating plate attached to the first core,
wherein
the first core comprises a first base portion and a first outer leg portion protruding from the first base portion and facing the second core with a gap therebetween;
the gap has a gap side portion between a first side surface of the first outer leg portion and a second side surface of the second core; and
the first heat-dissipating plate covers at least the first base portion or the first outer leg portion so that the gap side portion is at least partly free.

In the coil device according to the present invention, the first heat-dissipating plate covers at least the first base portion or the first outer leg portion so that the gap side portion is at least partly free. In this situation, the gap side portion is not entirely blocked with the first heat-dissipating plate due to its attachment. It is thus assumed that, over the gap side portion, a magnetic field generated at the gap side portion does not readily influence the first heat-dissipating plate to not readily generate an eddy current at the first heat-dissipating plate. This allows reduction of loss of the coil device to improve efficiency of the coil device. Also, as heat of the first core is transferred to the first heat-dissipating plate, heat-dissipation ability of the coil device can be improved.

The first heat-dissipating plate may comprise a side portion extending along the first side surface; and the side portion may cover the first side surface so that the gap side portion is entirely free. In this situation, the gap side portion is not at all blocked by the side portion. Thus, over the gap side portion, a magnetic field generated at the gap side portion does not readily influence the side portion to prevent generation of an eddy current at the side portion to enable reduction of loss.

The side portion may be disposed at a location apart from the gap side portion in an axial direction of the first outer leg portion. In this situation, over the first side surface, a magnetic field generated at the gap side portion does not readily influence the side portion to prevent generation of an eddy current at the side portion to enable reduction of loss.

The first heat-dissipating plate may comprise a side portion extending along the first side surface; and the side portion may cover the first side surface and the gap side portion so that the gap side portion is partly free. In this situation, the gap side portion is not entirely blocked with the side portion due to attachment of the first heat-dissipating plate. Thus, over the gap side portion, a magnetic field generated at the gap side portion does not readily influence the side portion to prevent generation of an eddy current at the side portion to enable reduction of loss.

The side portion may be in contact with the first side surface. In this situation, heat of the first core is readily transferred to the first heat-dissipating plate via the side portion, and the heat-dissipation ability of the coil device can be improved.

The first heat-dissipating plate may comprise a side portion extending along the first side surface; the side portion may comprise a first portion and a second portion closer to the second core than the first portion is; and the second portion may cover the second side surface and the gap side portion so that the gap side portion is at least partly free. In this situation, the gap side portion is not entirely blocked with the second portion due to attachment of the first heat-dissipating plate. Thus, over the gap side portion, a magnetic field generated at the gap side portion does not readily influence the second portion to prevent generation of an eddy current at the second portion to enable reduction of loss. Also, as heat of the second core is transferred to the first heat-dissipating plate via the second portion, the heat-dissipation ability of the coil device can be improved.

The first portion and the second portion may be connected using a step portion. In this situation, according to the length of the step portion, the second portion can be disposed at a location apart from the gap side portion. Thus, over the gap side portion, a magnetic field generated at the gap side portion does not readily influence the second portion to prevent generation of an eddy current at the second portion to enable reduction of loss.

The first portion may be in contact with the first side surface; the second portion may be apart from the gap side portion so that a space is provided between the second portion and the gap side portion; and the second portion may be apart from the second side surface so that a space is provided between the second portion and the second side surface. In this situation, according to the length of the space, the second portion can be disposed at a location apart from the gap side portion and the second side surface. Thus, over the gap side portion, a magnetic field generated at the gap side portion does not readily influence the second portion to prevent generation of an eddy current at the second portion to enable reduction of loss. Also, over the second side surface, a magnetic field generated at the gap side portion does not readily influence the second portion to prevent generation of an eddy current at the second portion to enable prevention of loss. Also, heat of the first core is readily transferred to the first heat-dissipating plate via the first portion, and the heat-dissipation ability of the coil device can be improved.

The first heat-dissipating plate may comprise a side portion extending along the first side surface; the side portion may comprise a first portion, a second portion closer to the second core than the first portion is, and a third portion between the first portion and the second portion; and the third portion may cover the gap side portion so that the gap side portion is at least partly free. In this situation, the gap side portion is not entirely blocked with the third portion due to attachment of the first heat-dissipating plate. Thus, over the gap side portion, a magnetic field generated at the gap side portion does not readily influence the third portion to prevent generation of an eddy current at the third portion to enable reduction of loss. Additionally, as heat of the first core is transferred to the first heat-dissipating plate via the first portion as well as heat of the second core is transferred to the first heat-dissipating plate via the second portion, the heat-dissipation ability of the coil device can be improved.

The first portion and the third portion may be connected using a first step portion; and the second portion and the third portion may be connected using a second step portion. In this situation, according to the lengths of the first step portion and the second step portion, the third portion can be disposed at a location apart from the gap side portion. Thus, over the gap side portion, a magnetic field generated at the gap side portion does not readily influence the third portion to prevent generation of an eddy current at the third portion to enable reduction of loss.

The first portion may be in contact with the first side surface; the second portion may be in contact with the second side surface; and the third portion may be apart from the gap side portion so that a space is provided between the third portion and the gap side portion. In this situation, according to the length of the space, the third portion can be disposed at a location apart from the gap side portion. Thus, over the gap side portion, a magnetic field generated at the gap side portion does not readily influence the third portion to prevent generation of an eddy current at the third portion to enable reduction of loss. Also, heat of the first core is readily transferred to the first heat-dissipating plate via the first portion as well as heat of the second core is readily transferred to the first heat-dissipating plate via the second portion, and the heat-dissipation ability of the coil device can be improved.

The first heat-dissipating plate may comprise a top panel portion continuing to the side portion and extending along a top surface of the first base portion. In this situation, as heat of the first core is transferred to the first heat-dissipating plate via the top panel portion, the heat-dissipation ability of the coil device can be improved.

A second heat-dissipating plate may be attached to the second core; and the second heat-dissipating plate may cover the second side surface so that the gap side portion is at least partly free. In this situation, the gap side portion is not entirely blocked with the second heat-dissipating plate due to its attachment. Thus, over the gap side portion, a magnetic field generated at the gap side portion does not readily influence the second heat-dissipating plate to prevent generation of an eddy current at the second heat-dissipating plate to enable reduction of loss. Also, as heat of the second core is transferred to the second heat-dissipating plate, the heat-dissipation ability of the coil device can be improved.

The second core may comprise a second base portion and a second outer leg portion protruding from the second base portion and facing the first outer leg portion with the gap therebetween. In this situation, the first core and the second core can be constituted by E-shaped cores, and magnetic properties of the coil device can be improved.

The bobbin may be accommodated in a case together with the first core having the first heat-dissipating plate attached. In this situation, as heat of the first core is transferred to the case via the first heat-dissipating plate, the heat-dissipation ability of the coil device can be improved.

The case may be filled with a heat-dissipating resin so that the first core and the second core are doused with the heat-dissipating resin. In this situation, as heat of the first core is transferred to the case via the first heat-dissipating plate and further the heat-dissipating resin, the heat-dissipation ability of the coil device can be improved.

### BRIEF DESCRIPTION OF THE DRAWING(S)

FIG. 1 is a perspective view of a coil device according to a first embodiment of the present invention.

FIG. 2 is an exploded perspective view of the coil device shown in FIG. 1.

FIG. 3 is a perspective view of the coil device shown in FIG. 1 with a case and a heat-dissipating resin omitted.

FIG. 4 is a sectional view along line IV-IV shown in FIG. 3.

FIG. 5 is a perspective view of a bobbin shown in FIG. 2.

FIG. 6 is a plan view of the bobbin shown in FIG. 5.

FIG. 7 is a perspective view of a coil device according to a second embodiment of the present invention.

FIG. 8 is a sectional view along line VIII-VIII shown in FIG. 7.

FIG. 9 is a perspective view of a coil device according to a third embodiment of the present invention.

FIG. 10 is a sectional view along line X-X shown in FIG. 9.

FIG. 11 is a sectional view of a coil device according to a fourth embodiment of the present invention.

FIG. 12A is a partial sectional view of a modified example of a heat-dissipating plate shown in FIG. 4.

FIG. 12B is a partial sectional view of another modified example of the heat-dissipating plate shown in FIG. 4.

FIG. 12C is a partial sectional view of still another modified example of the heat-dissipating plate shown in FIG. 4.

FIG. 12D is a partial sectional view of still another modified example of the heat-dissipating plate shown in FIG. 4.

FIG. 12E is a partial sectional view of a modified example of a heat-dissipating plate shown in FIG. 8.

FIG. 12F is a partial sectional view of another modified example of the heat-dissipating plate shown in FIG. 8.

### DETAILED DESCRIPTION

Hereinafter, embodiments of the present invention are described with reference to the drawings. The illustrations are only schematically and exemplarily provided for understanding of the present invention; and the appearance, dimensional ratios, etc. may be different from the actual ones. The present invention is not limited to the following embodiments.

### First Embodiment

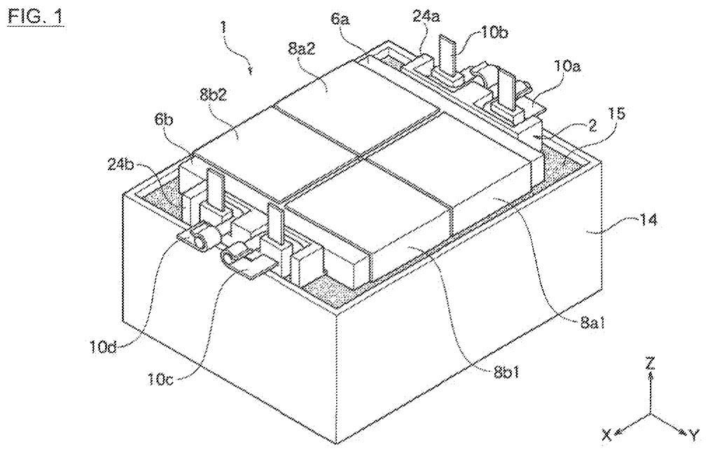

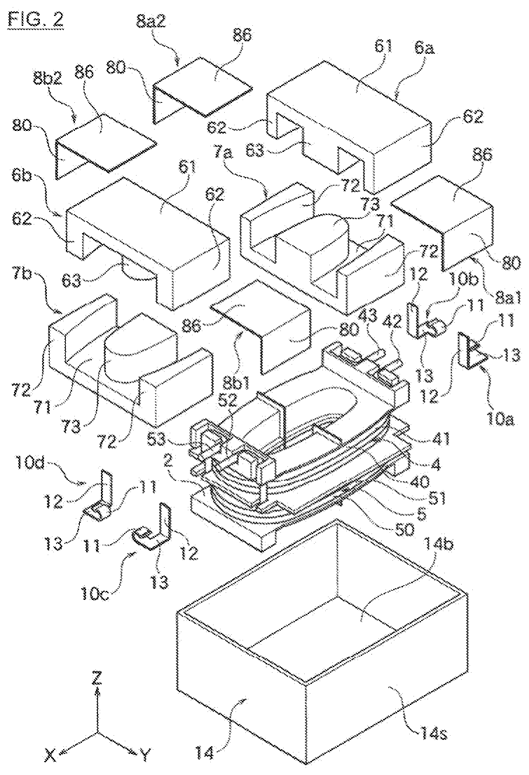

A coil device 1 according to a first embodiment of the present invention shown in FIG. 1 functions as, for example, a leakage transformer and is included in a power supply circuit or the like of an on-board charger or electronic equipment. As shown in FIG. 2, the coil device 1 at least includes a bobbin 2, a first coil 4, first cores 6a and 6b, second cores 7a and 7b, and a heat-dissipating plate 8a1. The coil device 1 of the present embodiment further includes a heat-dissipating plate 8a2, a heat-dissipating plate 8b1, a heat-dissipating plate 8b2, a second coil 5, terminals 10a to 10d, a case 14, and a heat-dissipating resin 15 (FIG. 1); however, these structures are not indispensable and may be omitted as necessary. The coil device 1 is a coil device in which an axis of the bobbin 2 or an axis of the first coil 4 (or the second coil 5) is disposed perpendicular to a mounting substrate (not illustrated in the drawings).

In FIG. 2 and other figures, the X-axis is an axis parallel to the direction in which the first cores 6a and 6b face each other. The Y-axis is an axis parallel to the direction in which the heat-dissipating plates 8a1 and 8a2 face each other. The Z-axis is an axis perpendicular to the X-axis and the Y-axis. In the following description, with regard to the X-axis, the Y-axis, and the Z-axis, a direction towards a center of the coil device 1 is referred to as an inward direction, and a direction away from the center of the coil device 1 is referred to as an outward direction.

The first cores 6a and 6b are E-shaped cores and have the same shape. A material of the first cores 6a and 6b is a magnetic material (e.g., metal or ferrites). In the present embodiment, the first cores 6a and 6b are separately provided; however, the first cores 6a and 6b may be integrally provided. Each of the first cores 6a and 6b includes a base portion 61 and outer leg portions 62. Each of the first cores 6a and 6b may further include a middle leg portion 63.

The base portion 61 is a plate having a thickness in the Z-axis direction. The outer leg portions 62 protrude from one surface in the Z-axis direction of the base portion 61. One outer leg portion 62 is provided at one end in the Y-axis direction of the base portion 61, and the other outer leg portion 62 is provided at the other end in the Y-axis direction of the base portion 61.

The middle leg portion 63 is located between the outer leg portions 62. The middle leg portion 63 protrudes from the one surface in the Z-axis direction of the base portion 61. The middle leg portion 63 is located at a center in the Y-axis direction of the base portion 61; however, the middle leg portion 63 may be shifted towards one side of the base portion 61 from its center in the Y-axis direction. The middle leg portion 63 has a semioval cross sectional shape (sectional shape perpendicular to an axial direction of the middle leg portion 63); however, the sectional shape may be semicircular, polygonal, or the like.

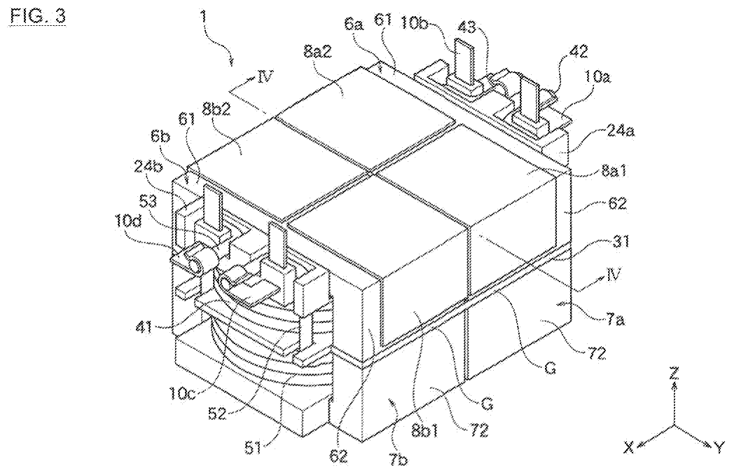

As shown in FIG. 3, the first cores 6a and 6b are disposed adjacent to each other along the X-axis. A gap is provided between the first cores 6a and 6b; however, the first cores 6a and 6b may be in contact with each other.

As shown in FIG. 2, the second cores 7a and 7b are E-shaped cores and have the same shape. A material of the second cores 7a and 7b is the same as the material of the first cores 6a and 6b; however, the material of the second cores 7a and 7b may be different from the material of the first cores 6a and 6b. In the present embodiment, the second cores 7a and 7b are separately provided; however, the second cores 7a and 7b may be integrally provided. Each of the second cores 7a and 7b includes a base portion 71 and outer leg portions 72. Each of the second cores 7a and 7b may further include a middle leg portion 73. The structure of the base portion 71 is similar to that of the base portion 61. The structure of the outer leg portions 72 is similar to that of the outer leg portions 62. The structure of the middle leg portion 73 is similar to that of the middle leg portion 63. In the present embodiment, both the first core 6a (6b) and the second core 7a (7b) are E-shaped cores, allowing improvement in magnetic properties of the coil device 1.

As shown in FIG. 3, the second cores 7a and 7b are disposed adjacent to each other along the X-axis. A gap is provided between the second cores 7a and 7b; however, the second cores 7a and 7b may be in contact with each other.

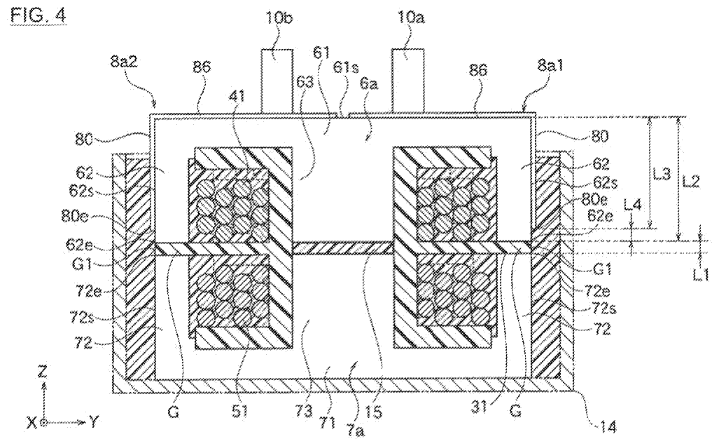

The first core 6a and the second core 7a are disposed to face each other along the Z-axis. Similarly, the first core 6b and the second core 7b are disposed to face each other along the Z-axis. The outer leg portions 62 of the first core 6a face the outer leg portions 72 of the second core 7a with a gap G therebetween. The outer leg portions 62 of the first core 6b face the outer leg portions 72 of the second core 7b with a gap G therebetween. As shown in FIG. 4, a length L1 of the gap G along the Z-axis is, for example, 1 to 3 mm. The length L1 of the gap G along the Z-axis may be 1.5 to 2.5 mm. The length L1 of the gap G along the Z-axis may be larger than the thickness of the heat-dissipating plate 8a1 described later.

In the present embodiment, a part (flange extending portions 31 described later) of the bobbin 2 is disposed in the gap G; however, the gap G may be provided with an air layer. Alternatively, the gap G may be filled with the heat-dissipating resin 15 (FIG. 1). Alternatively, a resin-made member (e.g., a resin-made sheet) made separately from the bobbin 2 may be disposed in the gap G.

Side surfaces 62s located at outer sides in the Y-axis direction of the outer leg portions 62 and side surfaces 72s located at outer sides in the Y-axis direction of the outer leg portions 72 are adjacent to each other along the Z-axis direction with the gap G therebetween. The corresponding side surfaces 62s and 72s are located on the same plane parallel to an XZ plane; however, it may be that the side surfaces 62s and 72s are not flush with each other.

Between the side surfaces 62s of the outer leg portions 62 and the side surfaces 72s of the outer leg portions 72, the gap G has gap side portions G1. The gap side portions G1 are portions of the gap G at its outer sides in the Y-axis direction. More specifically, the gap side portions G1 are portions located between extremity portions 62e of the outer leg portions 62 and extremity portions 72e of the outer leg portions 72. The extremity portions 62e are portions (portions extending along the X-axis) located at outer sides in the Y-axis direction in peripheral portions of extremity surfaces (surfaces parallel to an XY plane) of the outer leg portions 62. The extremity portions 72e are portions (portions extending along the X-axis) located at outer sides in the Y-axis direction in peripheral portions of extremity surfaces (surfaces parallel to an XY plane) of the outer leg portions 72. Between the corresponding side surfaces 62s and 72s, the gap side portions G1 constitute imaginary surfaces extending in parallel to the side surfaces 62s and 72s.

An extremity surface of the middle leg portion 63 and an extremity surface of the middle leg portion 73 face each other with a gap therebetween. The gap between the middle leg portions 63 and 73 is filled with the heat-dissipating resin 15. However, in the gap between the middle leg portions 63 and 73, a part of the bobbin 2 may be disposed, or a resin-made member (e.g., a resin-made sheet) made separately from the bobbin 2 may be disposed. Alternatively, the gap may be provided with an air layer.

As shown in FIG. 2, the bobbin 2 is provided with the first coil 4 and the second coil 5. The first coil 4 includes a winding portion 41, in which a wire 40 is wound in a coil shape, and lead-out portions 42 and 43 drawn from the winding portion 41. The second coil 5 includes a winding portion 51, in which a wire 50 is wound in a coil shape, and lead-out portions 52 and 53 drawn from the winding portion 51. Either the first coil 4 or the second coil 5 is a primary coil, and the other is a secondary coil.

Each of the wires 40 and 50 is a conductive core wire (e.g., round wire, rectangular wire, stranded wire, litz wire, or braided wire) made of copper or the like. Each of the wires 40 and 50 may be an insulation coated wire, in which such a conductive core wire is coated with insulating coating. Each of the wires 40 and 50 may have a diameter of, for example, 1.0 to 3.0 mm. The diameters of the wires 40 and 50 may be the same or different. For example, either one of the wires 40 and 50 for a larger current may have a diameter that is larger than the diameter of the other wire.

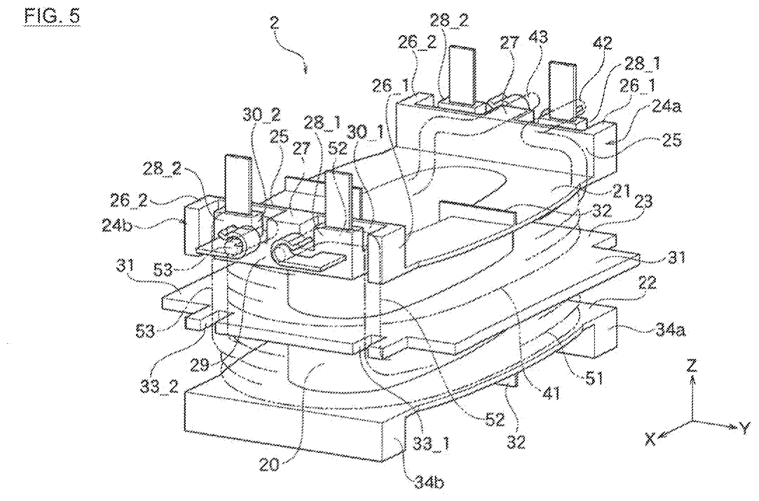

To the bobbin 2, the first core 6a and the second core 7a are attached so as to face each other along the Z-axis. Also, to the bobbin 2, the first core 6b and the second core 7b are attached so as to face each other along the Z-axis. As shown in FIG. 5, the bobbin 2 includes a tubular portion 20. The bobbin 2 may further include flange portions 21 to 23, terminal blocks 24a and 24b, locating portions 34a and 34b, the flange extending portions 31, protruding portions 32, and grooves 33_1 and 33_2. The bobbin 20 is made from, for example, plastics (e.g., PPS, PET, PBT, or LCP) or other insulating materials (preferably heat resistant materials).

The tubular portion 20 is a bottomless tubular body and has a through hole. Inside the tubular body 20, the respective middle leg portions 63 (FIG. 2) of the first cores 6a and 6b are inserted. Inside the tubular body 20, the respective middle leg portions 73 (FIG. 2) of the second cores 7a and 7b are inserted. The winding portion 41 of the first coil 4 is provided around a circumferential surface of the tubular portion 20, with the wire 40 wound therearound. The winding portion 51 of the second coil 5 is provided around the circumferential surface of the tubular portion 20, with the wire 50 wound therearound.

The flange portion 21 is provided at one end in the Z-axis direction of the tubular portion 20, and the flange portion 22 is provided at the other end in the Z-axis direction of the tubular portion 20. The flange portion 23 is located between the flange portions 21 and 22. The flange portions 21 to 23 protrude radially outwards from the circumferential surface of the tubular portion 20. The winding portion 41 is disposed between the flange portions 21 and 23, and the winding portion 51 is disposed between the flange portions 22 and 23. Lengths of radially outward protrusion of the flange portions 21 to 23 are not limited but are not smaller than a radial length of the winding portion 41 or 51.

The protruding portions 32 are provided at respective surfaces of the flange portions 21 and 22. Also, the protruding portions 32 are provided at an inner circumferential surface of the tubular portion 20. The protruding portions 32 protrude outwards along the Z-axis from the surfaces of the flange portions 21 and 22. Also, the protruding portions 32 protrude radially inwards from the inner circumferential surface of the tubular portion 20.

Some of the protruding portions 32 are disposed between the base portion 61 (FIG. 2) of the first core 6a and the base portion 61 of the first core 6b. Thus, between the base portion 61 of the first core 6a and the base portion 61 of the first core 6b is a gap having a length according to the thickness of the protruding portions 32 along the X-axis. Also, some of the protruding portions 32 are disposed between the middle leg portion 63 (FIG. 2) of the first core 6a and the middle leg portion 63 of the first core 6b. Thus, between the middle leg portion 63 of the first core 6a and the middle leg portion 63 of the first core 6b is a gap having a length according to the thickness of the protruding portions 32 along the X-axis.

Similarly, some of the protruding portions 32 are disposed between the base portion 71 (FIG. 2) of the second core 7a and the base portion 71 of the second core 7b. Thus, between the base portion 71 of the second core 7a and the base portion 71 of the second core 7b is a gap having a length according to the thickness of the protruding portions 32 along the X-axis. Also, some of the protruding portions 32 are disposed between the middle leg portion 73 of the second core 7a and the middle leg portion 73 of the second core 7b. Thus, between the middle leg portion 73 of the second core 7a and the middle leg portion 73 of the second core 7b is a gap having a length according to the thickness of the protruding portions 32 along the X-axis.

At peripheral portions of the flange portion 23, the flange extending portions 31 (in the present embodiment, two flange extending portions 31) are provided. One flange extending portion 31 is provided at one end in the Y-axis direction of the flange portion 23 and protrudes outwards along the Y-axis. The other flange extending portion 31 is provided at the other end in the Y-axis direction of the flange portion 23 and protrudes outwards along the Y-axis. The thickness of the flange extending portions 31 is equivalent to that of the flange portion 23. As shown in FIG. 3, the flange extending portions 31 are disposed in the gap G between the outer leg portions 62 of the first core 6a and the outer leg portions 72 of the second core 7a. Also, the flange extending portions 31 are disposed in the gap G between the outer leg portions 62 of the first core 6b and the outer leg portions 72 of the second core 7b.

As shown in FIG. 5, the grooves 33_1 and 33_2 are provided at one end in the X-axis direction of the flange portion 23 and are recessed radially inwards from a peripheral portion of the flange portion 23. Via the grooves 33_1 and 332, the lead-out portions 52 and 53 of the second coil 5 are drawn. Through the groove 331 passes the lead-out portion 52, which is drawn upwards from the winding portion 51 between the flange portions 22 and 23, along the Z-axis. Through the groove 332 passes the lead-out portion 53, which is drawn upwards from the winding portion 51 between the flange portions 22 and 23, along the Z-axis.

The terminal block 24a is provided at one end in the X-axis direction of the flange portion 21, and the terminal block 24b is provided at the other end in the X-axis direction of the flange portion 21. The terminal blocks 24a and 24b have the same shape but may have different shapes. The terminal block 24a includes a wall portion 25, side wall portions 26_1 and 262, a partition portion 27, columnar portions 28_1 and 282, a bottom portion 29, and lead-out paths 301 and 30_2.

The wall portion 25 and the side wall portions 26_1 and 26_2 protrude outwards along the Z-axis from a surface of the flange portion 21. The wall portion 25 extends along the Y-axis, and the side wall portions 26_1 and 26_2 extend along the X-axis. The wall portion 25 and the side wall portions 26_1 and 26_2 of the terminal block 24a insulate the lead-out portions 42 and 43 from the first core 6a (FIG. 2). A wall portion 25 and side wall portions 26_1 and 26_2 of the terminal block 24b insulate the lead-out portions 52 and 53 from the first core 6b (FIG. 2).

The bottom portion 29 protrudes along the X-axis outwards from one surface of the wall portion 25. The partition portion 27 is provided so as to extend over the wall portion 25 and the bottom portion 29. The partition portion 27 is located at a central portion in the Y-axis direction of the bottom portion 29. The partition portion 27 protrudes along the X-axis outwards from the one surface of the wall portion 25.

The columnar portions 28_1 and 282 protrude from the bottom portion 29 along the Z-axis. The columnar portion 28_1 is located at one side in the Y-axis direction from the partition portion 27, and the columnar portion 28_2 is located at the other side in the Y-axis direction from the partition portion 27.

The lead-out path 301 is provided around the columnar portion 28_1 and extends so as to surround the columnar portion 28_1. The lead-out path 30_1 consists of a path between the columnar portion 28_1 and the side wall portion 261, a path between the columnar portion 28_1 and the wall portion 25, and a path between the columnar portion 28_1 and the partition portion 27.

The lead-out path 302 is provided around the columnar portion 28_2 and extends so as to surround the columnar portion 28_2. The lead-out path 30_2 consists of a path between the columnar portion 28_2 and the side wall portion 262, a path between the columnar portion 28_2 and the wall portion 25, and a path between the columnar portion 28_2 and the partition portion 27.

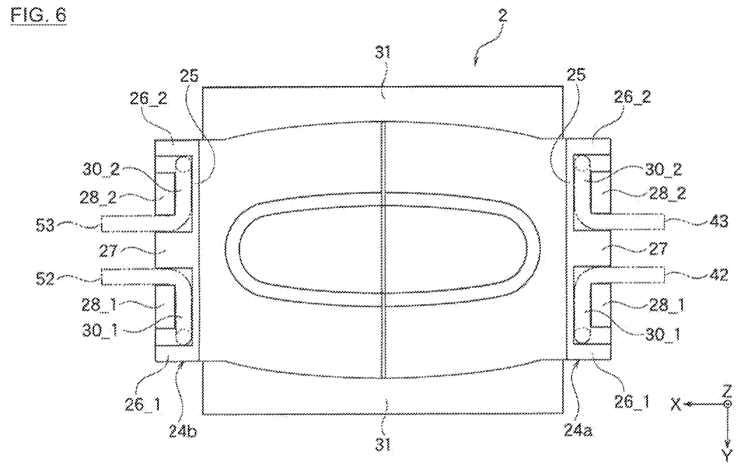

As shown in FIGS. 5 and 6, in a space between the flange portions 21 and 23, the lead-out portion 42 of the first coil 4 is drawn upwards from the winding portion 41 and is guided to the lead-out path 301 of the terminal block 24a. Then, the lead-out portion 42 passes along and through the lead-out path 301, being bent around the columnar portion 28_1 of the terminal block 24a, and is drawn outwards from the terminal block 24a in the X-axis direction.

In the space between the flange portions 21 and 23, the lead-out portion 43 of the first coil 4 is drawn upwards from the winding portion 41 and is guided to the lead-out path 30_2 of the terminal block 24a. Then, the lead-out portion 43 passes along and through the lead-out path 302, being bent around the columnar portion 28_2 of the terminal block 24a, and is drawn outwards from the terminal block 24a in the X-axis direction.

In a space between the flange portions 22 and 23, the lead-out portion 52 of the second coil 5 is drawn upwards from the winding portion 51 and is guided, via the groove 331, to a lead-out path 30_1 of the terminal block 24b. Then, the lead-out portion 52 passes along and through the lead-out path 301, being bent around a columnar portion 28_1 of the terminal block 24b, and is drawn outwards from the terminal block 24b in the X-axis direction.

In the space between the flange portions 22 and 23, the lead-out portion 53 of the second coil 5 is drawn upwards from the winding portion 51 and is guided, via the groove 33_2, to a lead-out path 30_2 of the terminal block 24b. Then, the lead-out portion 53 passes along and through the lead-out path 302, being bent around a columnar portion 28_2 of the terminal block 24b, and is drawn outwards from the terminal block 24b in the X-axis direction.

The locating portion 34a is provided at one end in the X-axis direction of the flange portion 22 and protrudes from the flange portion 22 along the Z-axis oppositely from the flange portion 23. The locating portion 34b is provided at the other end in the X-axis direction of the flange portion 22 and protrudes from the flange portion 22 along the Z-axis oppositely from the flange portion 23. Using the locating portions 34a and 34b, the bobbin 2 is placed on a bottom portion 14b (FIG. 2) of the case 14.

As shown in FIG. 2, the terminals 10a to 10d have the same shape and each include a wire joint portion 11, a connecting portion 12, and a middle portion 13. In the present embodiment, the terminals 10a and 10b are provided integrally at the terminal block 24a (FIG. 5) of the bobbin 2; however, the terminals 10a and 10b may be attached to the terminal block 24a afterwards. The terminals 10c and 10d are provided integrally at the terminal block 24b (FIG. 5) of the bobbin 2; however, the terminals 10c and 10d may be attached to the terminal block 24b afterwards.

The lead-out portion 42 of the first coil 4 is crimped to be connected to the wire joint portion 11 of the terminal 10a. The lead-out portion 43 of the first coil 4 is crimped to be connected to the wire joint portion 11 of the terminal 10b. The lead-out portion 52 of the second coil 5 is crimped to be connected to the wire joint portion 11 of the terminal 10c. The lead-out portion 53 of the second coil 5 is crimped to be connected to the wire joint portion 11 of the terminal 10d. The lead-out portions 42, 43, 52, and 53 may be welded to the wire joint portions 11. Alternatively, the lead-out portions 42, 43, 52, and 53 may be connected to the wire joint portions 11 using, for example, laser welding, soldering, conductive adhesives, thermocompression bonding, ultrasonic bonding, resistance brazing, or UV curing resin bonding.

Each connecting portion 12 is a portion that is connected to, for example, a mounting substrate. The connecting portion 12 protrudes along the Z-axis but may protrude along the X-axis or the Y-axis. As shown in FIGS. 2 and 5, the connecting portion 12 is partly embedded in the columnar portion 28_1 or 28_2 of the bobbin 2.

Each middle portion 13 is located between the wire joint portion 11 and the connecting portion 12 and continues to them. The middle portion 13 is at least partly embedded in the columnar portion 28_1 or 28_2 (FIG. 5) of the bobbin 2. The middle portion 13 may be at least partly embedded in the bottom portion 29 (FIG. 5) of the bobbin 2.

As shown in FIG. 2, the case 14 includes a side portion 14s and the bottom portion 14b. The case 14 is made of, for example, metal with excellent coolability (e.g., aluminum). The case 14 has an opening portion for accommodating the bobbin 2 having the first cores 6a and 6b, the second cores 7a and 7b, and the like attached. As shown in FIG. 1, the bobbin 2, the heat-dissipating plates 8a1, 8a2, 8b1, and 8b2, and the first cores 6a and 6b are each partly exposed from the opening portion of the case 14.

As shown in FIGS. 1 and 2, the case 14 can be filled with the heat-dissipating resin 15. The case 14 is filled with the heat-dissipating resin 15 so that the first cores 6a and 6b, the first coil 4, the second coil 5, the second cores 7a and 7b, and the heat-dissipating plates 8a1, 8a2, 8b1, and 8b2 are doused with the heat-dissipating resin 15. The heat-dissipating resin 15 is made from, for example, silicone resin, urethane resin, or epoxy resin. The case 14 is filled with the heat-dissipating resin 15 up to the vicinity of the opening portion of the case 14 (e.g., about 70% to 90% of the height of the side portion 14s along the Z-axis).

In the present embodiment, heat of the first coil 4, the second coil 5, the bobbin 2, the first cores 6a and 6b, the second cores 7a and 7b, and the like is efficiently dissipated outside via the case 14 and the heat-dissipating resin 15 to allow increase in cooling efficiency of the coil device 1.

As shown in FIG. 2, the heat-dissipating plates 8a1 and 8a2 have the same shape and are attached to the first core 6a using, for example, an adhesive or tape. However, the heat-dissipating resin 15 (FIG. 1) with which the case 14 is filled may be used to attach the heat-dissipating plates 8a1 and 8a2 to the first core 6a. The heat-dissipating plates 8a1 and 8a2 are made of metal (e.g., aluminum, copper, or silver) or resin. The heat-dissipating plate 8a1 is attached to one side in the Y-axis direction of the first core 6a, and the heat-dissipating plate 8a2 is attached to the other side in the Y-axis direction of the first core 6a. The heat-dissipating plates 8a1 and 8a2 are apart along the Y-axis.

The heat-dissipating plates 8b1 and 8b2 have the same shape and are attached to the first core 6b using, for example, an adhesive or tape. However, the heat-dissipating resin 15 (FIG. 1) with which the case 14 is filled may be used to attach the heat-dissipating plates 8b1 and 8b2 to the first core 6b. The heat-dissipating plates 8b1 and 8b2 are made of metal (e.g., aluminum, copper, or silver) or resin. The heat-dissipating plate 8b1 is attached to one side in the Y-axis direction of the first core 6b, and the heat-dissipating plate 8b2 is attached to the other side in the Y-axis direction of the first core 6b. The heat-dissipating plates 8b1 and 8b2 are apart along the Y-axis.

Each of the heat-dissipating plates 8a1, 8a2, 8b1, and 8b2 has an L shape and includes a side portion 80 and a top panel portion 86. Each of the heat-dissipating plates 8a1, 8a2, 8b1, and 8b2 may have any thickness. The thickness is 0.5 to 2 mm.

As shown in FIG. 4, the top panel portion 86 extends along a top surface 61s of the corresponding base portion 61. The top panel portion 86 abuts the top surface 61s so as to cover the base portion 61 from one side in the Z-axis direction. The side portion 80 is connected to one end in the Y-axis direction of the top panel portion 86 and extends along the side surface 62s of the corresponding outer leg portion 62 so as to be orthogonal to the top panel portion 86. The side portion 80 abuts the side surface 62s so as to cover the outer leg portion 62 from one side (outside) in the Y-axis direction. The side portion 80 is partly covered with the heat-dissipating resin 15 with which the case 14 is filled. Each of the heat-dissipating plates 8a1 and 8a2 covers both of the base portion 61 and the outer leg portion 62; however, as described later, each of the heat-dissipating plates 8a1 and 8a2 may cover only either the base portion 61 or the outer leg portion 62.

L3 denotes the length of the side portion 80 along the Z-axis. L2 denotes the length between the top surface 61s of the base portion 61 and the extremity portion 62e of the outer leg portion 62. In the present embodiment, L3<L2 is satisfied. However, as described later, L3=L2 or L3>L2 may be satisfied. Also, in the present embodiment, L3>L2/2 is satisfied; however, L3=L2/2 or L3<L2/2 may be satisfied.

An extremity portion 80e of the side portion 80 is located at a location apart from the extremity portion 62e of the outer leg portion 62 along the Z-axis closer to the top surface 61s. That is, the side portion 80 is located at a location over the side surface 62s and apart from the corresponding gap side portion G1 along the Z-axis closer to the top surface 61s. L4 denotes the distance between the extremity portion 80e of the side portion 80 and the extremity portion 62e of the outer leg portion 62. In the present embodiment, L4=L1 is satisfied; however, L4>L1, L4≥2L1, or L4≥3L1 may be satisfied. Also, L4≥L1/5 or L4≥L1/2 may be satisfied. Alternatively, L4<L1 or L4≤L1/2 may be satisfied. L1 is the length of the gap G along the Z-axis.

The heat-dissipating plate 8a1 covers the base portion 61 and the outer leg portion 62 from outside in the Y-axis direction so that the gap side portion G1 of the gap G is at least partly free (in the present embodiment, the gap side portion G1 is entirely free). Also, the side portion 80 covers the side surface 62s from outside in the Y-axis direction so that the gap side portion G1 is entirely free. Thus, the gap side portion G1 is directly covered with the heat-dissipating resin 15 with which the case 14 is filled, without the side portion 80 being interposed therebetween. In the present embodiment, the gap side portion G1 is entirely and directly covered with the heat-dissipating resin 15; however, as described later, the gap side portion G1 may partly be directly covered with the heat-dissipating resin 15. When the case 14 is not filled with the heat-dissipating resin 15, the gap side portion G1 may be covered with an air layer inside the case 14.

Similarly to the heat-dissipating plate 8a1, the heat-dissipating plate 8a2 covers the base portion 61 and the corresponding outer leg portion 62 so that the corresponding gap side portion G1 is at least partly free (in the present embodiment, the gap side portion G1 is entirely free).

Although detailed illustration is omitted, each of the heat-dissipating plates 8b1 and 8b2 (FIG. 2) covers the corresponding base portion 61 and the corresponding outer leg portion 62 so that the corresponding gap side portion G1 (the gap side portion G1 of the gap G provided between the outer leg portion 62 of the first core 6b and the outer leg portion 72 of the second core 7b) is at least partly free (in the present embodiment, the gap side portion G1 is entirely free).

Now, a method of manufacturing the coil device 1 is described. First, the members shown in FIG. 2 are prepared. As shown in FIG. 3, the terminal blocks 24a and 24b of the bobbin 2 are integrally provided with the terminals 10a to 10d. Next, as shown in FIGS. 2 and 5, the wire 40 is wound around the circumferential surface of the tubular portion 20 of the bobbin 2 to form the winding portion 41. From the winding portion 41, the lead-out portion 42 is drawn upwards towards the terminal block 24a. Then, as shown in FIG. 6, via the lead-out path 30_1 of the terminal block 24a, the lead-out portion 42 is drawn outwards from the terminal block 24a in the X-axis direction. Also, as shown in FIG. 5, the lead-out portion 43 is drawn upwards from the winding portion 41 towards the terminal block 24a. Then, via the lead-out path 302 of the terminal block 24a, the lead-out portion 43 is drawn outwards from the terminal block 24a in the X-axis direction.

Next, as shown in FIG. 5, the wire 50 is wound around the circumferential surface of the tubular portion 20 of the bobbin 2 to form the winding portion 51. From the winding portion 51, the lead-out portion 52 is drawn upwards towards the terminal block 24b via the groove 33_1. Then, as shown in FIG. 6, via the lead-out path 301 of the terminal block 24b, the lead-out portion 52 is drawn outwards from the terminal block 24b in the X-axis direction. Also, as shown in FIG. 5, the lead-out portion 53 is drawn upwards from the winding portion 51 towards the terminal block 24b via the groove 33_2. Then, as shown in FIG. 6, via the lead-out path 30_2 of the terminal block 24b, the lead-out portion 53 is drawn outwards from the terminal block 24b in the X-axis direction.

Next, as shown in FIG. 3, the lead-out portion 42 is connected to the terminal 10a (its wire joint portion 11), and the lead-out portion 43 is connected to the terminal 10b (its wire joint portion 11). Also, the lead-out portion 52 is connected to the terminal 10c (its wire joint portion 11), and the lead-out portion 53 is connected to the terminal 10d (its wire joint portion 11).

Next, the first core 6a and the second core 7a are attached to the bobbin 2 so as to face each other, and the first core 6b and the second core 7b are attached to the bobbin 2 so as to face each other. As necessary, the first core 6a and the second core 7a may be adhered, or the first core 6b and the second core 7b may be adhered.

Next, the heat-dissipating plates 8a1 and 8a2 are attached to the first core 6a. As shown in FIG. 4, at one side in the Y-axis direction, the heat-dissipating plate 8a1 is attached so as to extend from the top surface 61s of the base portion 61 to the side surface 62s of the corresponding outer leg portion 62. At the other side in the Y-axis direction, the heat-dissipating plate 8a2 is attached so as to extend from the top surface 61s of the base portion 61 to the side surface 62s of the corresponding outer leg portion 62. Similarly, as shown in FIG. 3, the heat-dissipating plates 8b1 and 8b2 are attached to the first core 6b. As necessary, the first core 6a and the heat-dissipating plates 8a1 and 8a2 may be fixed to each other using an adhesive or the like. Also, the first core 6b and the heat-dissipating plates 8b1 and 8b2 may be fixed to each other using an adhesive or the like.

Next, as shown in FIG. 1, the bobbin 2 having the first core 6a and the like attached is accommodated in the case 14. Then, the case 14 is filled with the heat-dissipating resin 15. In the above manner, the coil device 1 can be manufactured.

As shown in FIG. 4, in the coil device 1 of the present embodiment, the heat-dissipating plate 8a1 covers at least the base portion 61 or the outer leg portion 62 (in the present embodiment, both the base portion 61 and the outer leg portion 62) so that the corresponding gap side portion G1 is at least partly free (in the present embodiment, the gap side portion G1 is entirely free). Thus, the gap side portion G1 is not entirely blocked with the heat-dissipating plate 8a1 due to its attachment. It is thus assumed that, over the gap side portion G1, a magnetic field generated at the gap side portion G1 does not readily influence the heat-dissipating plate 8a1 to not readily generate an eddy current at the heat-dissipating plate 8a1. This allows reduction of loss of the coil device 1 to improve efficiency of the coil device 1. Also, because heat of the first core 6a is transferred to the heat-dissipating plate 8a1, heat-dissipation ability of the coil device 1 can be improved.

The side portion 80 covers the side surface 62s of the outer leg portion 62 so that the gap side portion G1 is entirely free. Thus, the gap side portion G1 is not at all blocked by the side portion 80. Therefore, over the gap side portion G1, a magnetic field generated at the gap side portion G1 does not readily influence the side portion 80 to prevent generation of an eddy current at the side portion 80 to enable reduction of loss.

According to experiments by the present inventors and the like, it is confirmed that, the farther the extremity portion 80e of the side portion 80 is from the gap side portion G1 along the Z-axis (i.e., the shorter the length L3 of the side portion 80 along the Z-axis shown in FIG. 4), the larger the effects of loss reduction. For example, when the length L3 of the side portion 80 along the Z-axis is less than one half the length L2 between the top surface 61s of the base portion 61 and the extremity portion 62e of the outer leg portion 62, loss can be further reduced.

The side portion 80 is disposed at a location apart from the gap side portion G1 along the Z-axis. Thus, over the side surface 62s, a magnetic field generated at the gap side portion G1 does not readily influence the side portion 80 to prevent generation of an eddy current at the side portion 80 to enable reduction of loss.

The side portion 80 is in contact with the side surface 62s. Thus, heat of the first core 6a is readily transferred to the heat-dissipating plate 8a1 via the side portion 80, and the heat-dissipation ability of the coil device 1 can be improved.

The heat-dissipating plate 8a1 includes the top panel portion 86 continuing to the side portion 80 and extending along the top surface 61s of the base portion 61. Thus, as heat of the first core 6a is transferred to the heat-dissipating plate 8a1 via the top panel portion 86, the heat-dissipation ability of the coil device 1 can be improved.

The bobbin 2 is accommodated in the case 14 together with the first core 6a having the heat-dissipating plate 8a1 attached. Thus, as heat of the first core 6a is transferred to the case 14 via the heat-dissipating plate 8a1, the heat-dissipation ability of the coil device 1 can be improved.

The case 14 is filled with the heat-dissipating resin 15 so that the first core 6a and the second core 7a are doused with the heat-dissipating resin 15. Thus, as heat of the first core 6a is transferred to the case 14 via the heat-dissipating plate 8a1 and further the heat-dissipating resin 15, the heat-dissipation ability of the coil device 1 can be improved.

### Second Embodiment

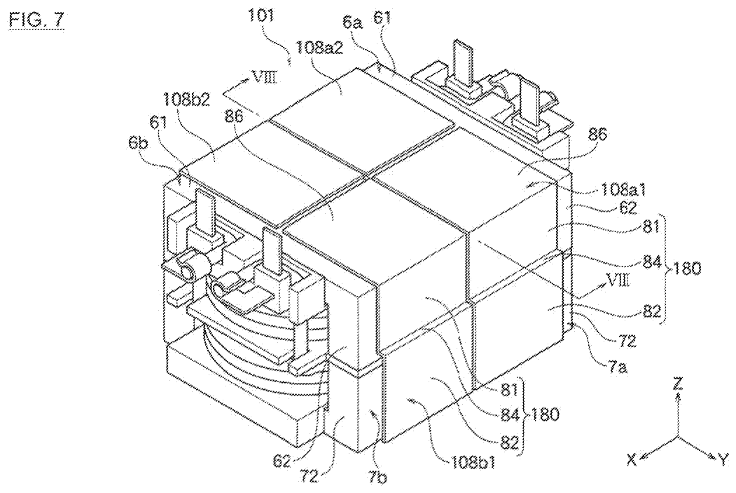

A coil device 101 of a second embodiment shown in FIG. 7 has structures similar to those of the coil device 1 of the first embodiment except for the following. Parts common to the coil device 1 of the first embodiment are given the same reference numerals, and their detailed description is omitted.

The coil device 101 includes heat-dissipating plates 108a1 and 108a2 and heat-dissipating plates 108b1 and 108b2. The heat-dissipating plates 108a1 and 108a2 have the same shape, and the heat-dissipating plates 108b1 and 108b2 have the same shape. Each of the heat-dissipating plates 108a1, 108a2, 108b1, and 108b2 has an L shape and includes a side portion 180 instead of the side portion 80 (FIG. 2) of the first embodiment. Each of the heat-dissipating plates 108a1, 108a2, 108b1, and 108b2 covers the corresponding base portion 61 and the corresponding outer leg portions 62 and 72. However, the heat-dissipating plates 108a1, 108a2, 108b1, and 108b2 may cover only the outer leg portions 62 and 72, with the top panel portions 86 being omitted from the heat-dissipating plates 108a1, 108a2, 108b1, and 108b2.

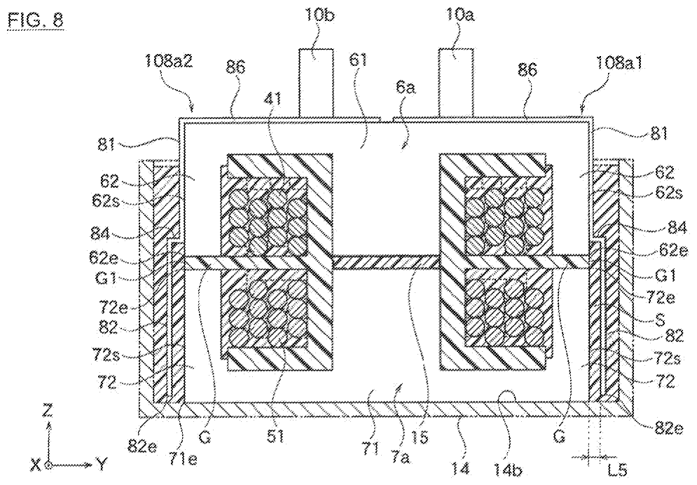

Each side portion 180 includes a first portion 81, a second portion 82, and a step portion 84. As shown in FIG. 8, the first portion 81 is closer to the first core 6a than the second portion 82 is. The first portion 81 is connected to one end in the Y-axis direction of the top panel portion 86 and extends along the side surface 62s of the corresponding outer leg portion 62 so as to be orthogonal to the top panel portion 86. The first portion 81 is in contact with the side surface 62s so as to cover the outer leg portion 62 from one side (outside) in the Y-axis direction. The first portion 81 is partly covered with the heat-dissipating resin 15 with which the case 14 is filled. The length of the first portion 81 along the Z-axis is equivalent to the length L3 (FIG. 4) of the side portion 80 of the first embodiment along the Z-axis but may be longer or shorter than the length 13.

The step portion 84 continues from the first portion 81 and extends in a direction away from the side surface 62s along the Y-axis so as to be orthogonal to the first portion 81. However, the step portion 84 may extend diagonally relative to the first portion 81. The step portion 84 is located between the first portion 81 and the second portion 82 and connects them.

The second portion 82 is closer to the second core 7a than the first portion 81 is. The second portion 82 continues from the step portion 84 and extends towards the bottom portion 14b of the case 14 along the Z-axis so as to be orthogonal to the step portion 84. The second portion 82 extends along the outer leg portion 62 of the first core 6a and the outer leg portion 72 of the second core 7a. More specifically, the second portion 82 and the side surface 62s of the outer leg portion 62 are disposed in parallel, and the second portion 82 and the side surface 72s of the outer leg portion 72 are disposed in parallel. An extremity portion 82e of the second portion 82 is disposed at a location apart from the bottom portion 14b of the case 14. However, the extremity portion 82e may abut the bottom portion 14b of the case 14.

The second portion 82 is disposed over the side surface 62s, the corresponding gap side portion G1, and the side surface 72s. However, the second portion 82 may be disposed only over the gap side portion G1 and the side surface 72s. Alternatively, the second portion 82 may be disposed only over the side surface 62s and the gap side portion G1. Alternatively, the second portion 82 may be disposed only over the gap side portion G1.

The second portion 82 covers the gap side portion G1 and the side surface 72s of the outer leg portion 72 from outside in the Y-axis direction so that the gap side portion G1 is at least partly free. In the present embodiment, the second portion 82 covers the gap side portion G1 and the side surface 72s from outside in the Y-axis direction so that the gap side portion G1 is entirely free. However, the second portion 82 may cover the gap side portion G1 and the side surface 72s from outside in the Y-axis direction so that the gap side portion G1 is partly free.

The second portion 82 covers, in addition to the side surface 72s and the gap side portion G1, the side surface 62s from outside in the Y-axis direction. However, the second portion 82 may cover only the gap side portion G1 and the side surface 72s from outside in the Y-axis direction. Alternatively, the second portion 82 may cover only the side surface 62s and the gap side portion G1 from outside in the Y-axis direction. Alternatively, the second portion 82 may cover only the gap side portion G1 from outside in the Y-axis direction.

The second portion 82 is apart from the gap side portion G1 so that a space S is provided between the second portion 82 and the gap side portion G1. Also, the second portion 82 is apart from the side surface 72s so that the space S is provided between the second portion 82 and the side surface 72s. The space S is filled with the heat-dissipating resin 15; however, the space S may be provided with an air layer.

L5 denotes the length of the space S between the second portion 82 and the gap side portion G1 (or the side surface 72s of the outer leg portion 72). In the present embodiment, L5=L1 (FIG. 4) is satisfied; however, L5>L1, L5≥2L1, or L5≥3L1 may be satisfied. Also, L5≥L1/5 or L5≥L1/2 may be satisfied. Alternatively, L5<L1 or L5≤L1/2 may be satisfied. L1 is the length of the gap G along the Z-axis.

The gap side portion G1 is directly covered with the heat-dissipating resin 15 with which the case 14 is filled, without abutting the second portion 82. In the present embodiment, the gap side portion G1 is entirely and directly covered with the heat-dissipating resin 15; however, the gap side portion G1 may partly be directly covered with the heat-dissipating resin 15. When the case 14 is not filled with the heat-dissipating resin 15, the gap side portion G1 may be covered with an air layer inside the case 14.

Similarly to the heat-dissipating plate 108a1, the heat-dissipating plate 108a2 covers the base portion 61, the corresponding outer leg portion 62, the corresponding gap side portion G1, and the corresponding outer leg portion 72 so that the gap side portion G1 is at least partly free (in the present embodiment, the gap side portion G1 is entirely free).

Although detailed illustration is omitted, each of the heat-dissipating plates 108b1 and 108b2 (FIG. 7) covers the corresponding base portion 61, the corresponding outer leg portion 62, the corresponding gap side portion G1, and the corresponding outer leg portion 72 so that the gap side portion G1 (the gap side portion G1 of the gap G provided between the outer leg portion 62 of the first core 6b and the outer leg portion 72 of the second core 7b) is at least partly free (in the present embodiment, the gap side portion G1 is entirely free).

In the present embodiment, effects similar to those of the first embodiment can be attained as well. Additionally, in the present embodiment, the second portion 82 covers the side surface 72s and the gap side portion G1 so that the gap side portion G1 is at least partly free (in the present embodiment, the gap side portion G1 is entirely free). Thus, the gap side portion G1 is not entirely blocked with the second portion 82 due to attachment of the heat-dissipating plate 108a1. This makes, over the gap side portion G1, a magnetic field generated at the gap side portion G1 not readily influence the second portion 82 to prevent generation of an eddy current at the second portion 82, enabling reduction of loss. Also, as heat of the second core 7a is transferred to the heat-dissipating plate 108a1 via the second portion 82, the heat-dissipation ability of the coil device 101 can be improved.

The first portion 81 and the second portion 82 are connected using the step portion 84. Thus, according to the length of the step portion 84, the second portion 82 can be disposed at a location apart from the gap side portion G1. This makes, over the gap side portion G1, a magnetic field generated at the gap side portion G1 not readily influence the second portion 82 to prevent generation of an eddy current at the second portion 82, enabling reduction of loss.

The first portion 81 is in contact with the side surface 62s. Further, the second portion 82 is apart from the gap side portion G1 and the side surface 72s so that the space S is provided. Thus, according to the length of the space S, the second portion 82 can be disposed at a location apart from the gap side portion G1 and the side surface 72s. This makes, over the gap side portion G1, a magnetic field generated at the gap side portion G1 not readily influence the second portion 82 to prevent generation of an eddy current at the second portion 82, enabling reduction of loss. Also, over the side surface 72s, a magnetic field generated at the gap side portion G1 does not readily influence the second portion 82 to prevent generation of an eddy current at the second portion 82, enabling prevention of loss. Also, heat of the first core 6a is readily transferred to the heat-dissipating plate 108a1 via the first portion 81, and the heat-dissipation ability of the coil device 101 can be improved.

### Third Embodiment

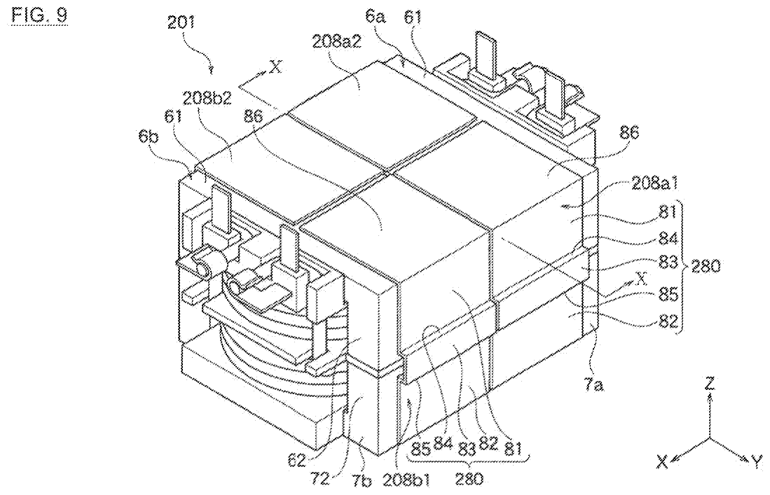

A coil device 201 of a third embodiment shown in FIG. 9 has structures similar to those of the coil device 101 of the second embodiment except for the following. Parts common to the coil device 101 of the second embodiment are given the same reference numerals, and their detailed description is omitted.

The coil device 201 includes heat-dissipating plates 208a1 and 208a2 and heat-dissipating plates 208b1 and 208b2. The heat-dissipating plates 208a1 and 208a2 have the same shape, and the heat-dissipating plates 208b1 and 208b2 have the same shape. Each of the heat-dissipating plates 208a1, 208a2, 208b1, and 208b2 has an L shape and includes a side portion 280 instead of the side portion 180 (FIG. 7) of the second embodiment. Each of the heat-dissipating plates 208a1, 208a2, 208b1, and 208b2 covers the corresponding base portion 61 and the corresponding outer leg portions 62 and 72. However, the heat-dissipating plates 208a1, 208a2, 208b1, and 208b2 may cover only the outer leg portions 62 and 72, with the top panel portions 86 being omitted from the heat-dissipating plates 208a1, 208a2, 208b1, and 208b2.

Each side portion 280 includes a first portion 81, a second portion 82, a third portion 83, a step portion 84, and a step portion 85. The structures of the first portion 81 and the step portion 84 of the present embodiment are similar to those of the first portion 81 (FIG. 7) and the step portion 84 of the second embodiment.

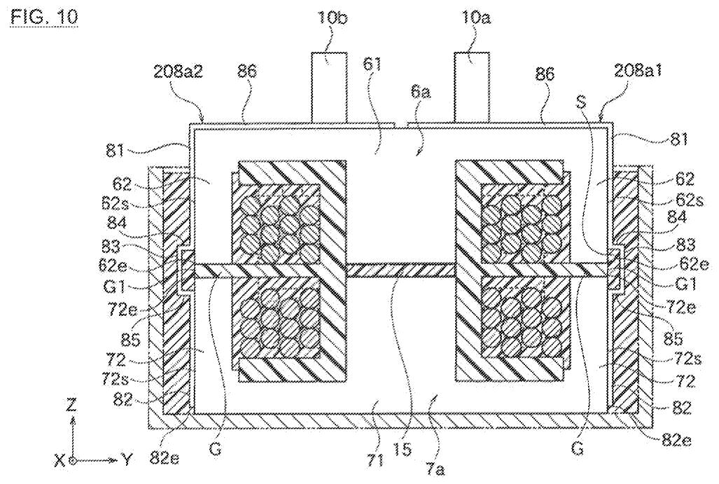

As shown in FIG. 10, the second portion 82 is closer to the second core 7a than the first portion 81 is. The second portion 82 extends along the side surface 72s of the corresponding outer leg portion 72 towards the bottom portion 14b of the case 14. The second portion 82 abuts the side surface 72s so as to cover the outer leg portion 72 from one side (outside) in the Y-axis direction. The second portion 82 is covered with the heat-dissipating resin 15 with which the case 14 is filled. The length of the second portion 82 along the Z-axis is equivalent to the length of the first portion 81 along the Z-axis but may be longer or shorter than the length of the first portion 81. An extremity portion 82e of the second portion 82 is disposed at a location apart from the bottom portion 14b of the case 14. However, the extremity portion 82e may abut the bottom portion 14b.

The third portion 83 is between the first portion 81 and the second portion 82 and extends along the corresponding outer leg portion 62, the corresponding gap side portion G1, and the outer leg portion 72. The third portion 83 is disposed in parallel to the side surface 62s of the outer leg portion 62, the gap side portion G1, and the side surface 72s of the outer leg portion 72. The third portion 83 is disposed over the side surface 62s, the gap side portion G1, and the side surface 72s. However, the third portion 83 may be disposed only over the side surface 62s and the gap side portion G1. Alternatively, the third portion 83 may be disposed only over the gap side portion G1 and the side surface 72s. Alternatively, the third portion 83 may be disposed only over the gap side portion G1.

The step portion 84 connects the first portion 81 and the third portion 83, and the step portion 85 connects the second portion 82 and the third portion 83. The step portions 84 and 85 extend so as to be orthogonal to the third portion 83 but may extend diagonally relative to the third portion 83.

The third portion 83 covers the gap side portion G1 so that the gap side portion G1 is at least partly free. In the present embodiment, the third portion 83 covers the gap side portion G1 from outside in the Y-axis direction so that the gap side portion G1 is entirely free. However, the third portion 83 may cover the gap side portion G1 from outside in the Y-axis direction so that the gap side portion G1 is partly free.

In the present embodiment, the third portion 83 covers, in addition to the gap side portion G1, the side surface 62s and the side surface 72s from outside in the Y-axis direction. However, the third portion 83 may cover only the side surface 62s and the gap side portion G1 from outside in the Y-axis direction. Alternatively, the third portion 83 may cover only the gap side portion G1 and the side surface 72s from outside in the Y-axis direction. Alternatively, the third portion 83 may cover only the gap side portion G1 from outside in the Y-axis direction.

The third portion 83 is apart from the gap side portion G1 so that a space S is provided between the third portion 83 and the gap side portion G1. Also, the third portion 83 is apart from the side surface 62s so that the space S is provided between the third portion 83 and the side surface 62s. Also, the third portion 83 is apart from the side surface 72s so that the space S is provided between the third portion 83 and the side surface 72s. The space S is surrounded by the third portion 83 and the step portions 84 and 85. The space S is filled with the heat-dissipating resin 15; however, the space S may be provided with an air layer. The length of the space S of the present embodiment along the Y-axis is equivalent to the length L5 (FIG. 8) of the space S of the second embodiment along the Y-axis but may be different from the length L5.

The gap side portion G1 is directly covered with the heat-dissipating resin 15 with which the case 14 is filled, without abutting the third portion 83. In the present embodiment, the gap side portion G1 is entirely and directly covered with the heat-dissipating resin 15; however, the gap side portion G1 may partly be directly covered with the heat-dissipating resin 15. When the case 14 is not filled with the heat-dissipating resin 15, the gap side portion G1 may be covered with an air layer inside the case 14.

Similarly to the heat-dissipating plate 208a1, the heat-dissipating plate 208a2 covers the base portion 61, the corresponding outer leg portion 62, the corresponding gap side portion G1, and the corresponding outer leg portion 72 so that the gap side portion G1 is at least partly free (in the present embodiment, the gap side portion G1 is entirely free).

Although detailed illustration is omitted, each of the heat-dissipating plates 208b1 and 208b2 (FIG. 9) covers the corresponding base portion 61, the corresponding outer leg portion 62, the corresponding gap side portion G1, and the corresponding outer leg portion 72 so that the gap side portion G1 (the gap side portion G1 of the gap G provided between the outer leg portion 62 of the first core 6b and the outer leg portion 72 of the second core 7b) is at least partly free (in the present embodiment, the gap side portion G1 is entirely free).

In the present embodiment, effects similar to those of the second embodiment can be attained as well. Additionally, in the present embodiment, the third portion 83 covers the gap side portion G1 so that the gap side portion G1 is at least partly free (in the present embodiment, the gap side portion G1 is entirely free). Thus, the gap side portion G1 is not entirely blocked with the third portion 83 due to attachment of the heat-dissipating plate 208a1. This makes, over the gap side portion G1, a magnetic field generated at the gap side portion G1 not readily influence the third portion 83 to prevent generation of an eddy current at the third portion 83, enabling reduction of loss. Additionally, as heat of the first core 6a is transferred to the heat-dissipating plate 208a1 via the first portion 81 as well as heat of the second core 7a is transferred to the heat-dissipating plate 208a1 via the second portion 82, the heat-dissipation ability of the coil device 201 can be improved.

The first portion 81 and the third portion 83 are connected using the step portion 84, and the second portion 82 and the third portion 83 are connected using the step portion 85. Thus, according to the respective lengths of the step portions 84 and 85, the third portion 83 can be disposed at a location apart from the gap side portion G1. This makes, over the gap side portion G1, a magnetic field generated at the gap side portion G1 not readily influence the third portion 83 to prevent generation of an eddy current at the third portion 83, enabling reduction of loss.

The first portion 81 is in contact with the side surface 62s. The second portion 82 is in contact with the side surface 72s. The third portion 83 is apart from the gap side portion G1 so that the space S is provided. Thus, according to the length of the space S, the third portion 83 can be disposed at a location apart from the gap side portion G1. This makes, over the gap side portion G1, a magnetic field generated at the gap side portion G1 not readily influence the third portion 83 to prevent generation of an eddy current at the third portion 83, enabling reduction of loss. Also, heat of the first core 6a is readily transferred to the heat-dissipating plate 208a1 via the first portion 81 as well as heat of the second core 7a is transferred to the heat-dissipating plate 208a1 via the second portion 82, and the heat-dissipation ability of the coil device 201 can be improved.

### Fourth Embodiment

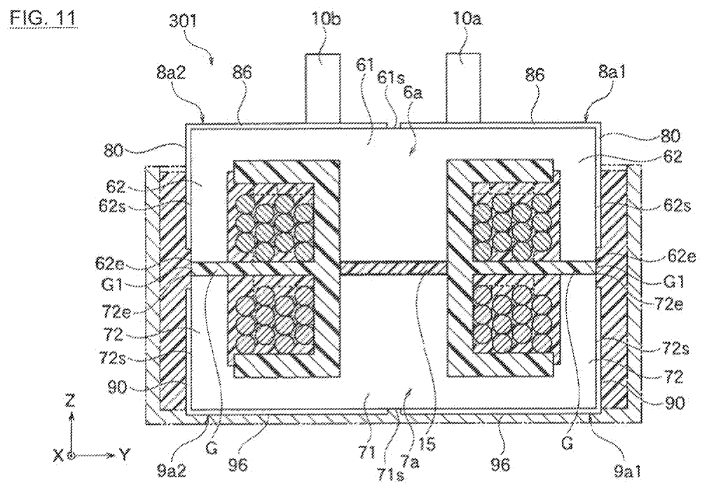

A coil device 301 of a fourth embodiment shown in FIG. 11 has structures similar to those of the coil device 1 of the first embodiment except for the following. Parts common to the coil device 1 of the first embodiment are given the same reference numerals, and their detailed description is omitted.

The coil device 301 includes heat-dissipating plates 9a1 and 9a2. Each of the heat-dissipating plates 9a1 and 9a2 includes a side portion 90 and a top panel portion 96. The side portion 90 abuts the side surface 72s of the corresponding outer leg portion 72 of the second core 7a. The structure of the side portion 90 is similar to that of the side portion 80. Also, how the side portion 90 is attached to the side surface 72s is similar to how the side portion 80 is attached to the side surface 62s.

The top panel portion 96 abuts a top surface 71s of the base portion 71 of the second core 7a. The structure of the top panel portion 96 is similar to that of the top panel portion 86. Also, how the top panel portion 96 is attached to the top surface 71s is similar to how the top panel portion 86 is attached to the top surface 61s. Although detailed illustration is omitted, heat-dissipating plates similar to the heat-dissipating plates 9a1 and 9a2 may be attached to the second core 7b as well.

In the present embodiment, effects similar to those of the first embodiment can be attained as well. Additionally, in the present embodiment, the heat-dissipating plate 9a1 (the side portion 90) covers the side surface 72s so that the gap side portion G1 is at least partly free (in the present embodiment, the gap side portion G1 is entirely free). Thus, the gap side portion G1 is not entirely blocked with the heat-dissipating plate 9a1 (the side portion 90) due to attachment of the heat-dissipating plate 9a1. Thus, over the gap side portion G1, a magnetic field generated at the gap side portion G1 does not readily influence the heat-dissipating plate 9a1 (the side portion 90) to prevent generation of an eddy current at the heat-dissipating plate 9a1 (the side portion 90) to enable reduction of loss. Also, as heat of the second core 7a is transferred to the heat-dissipating plate 9a1 (the side portion 90), the heat-dissipation ability of the coil device 301 can be improved.

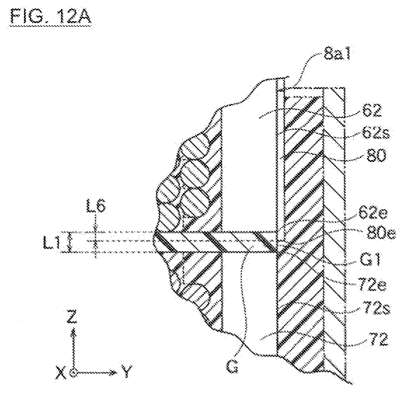

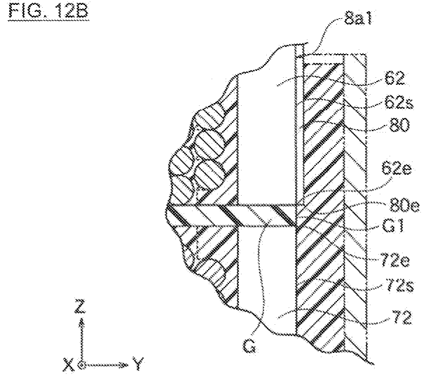

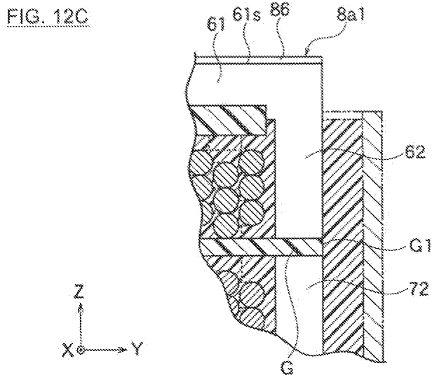

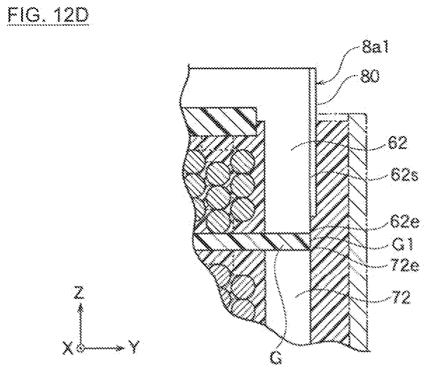

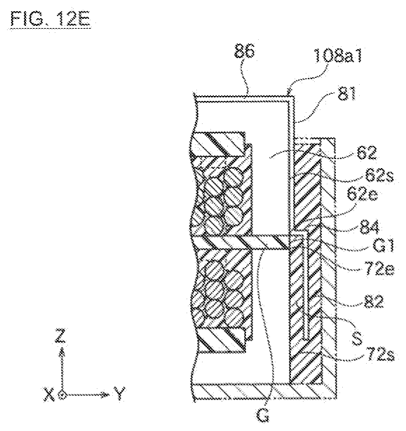

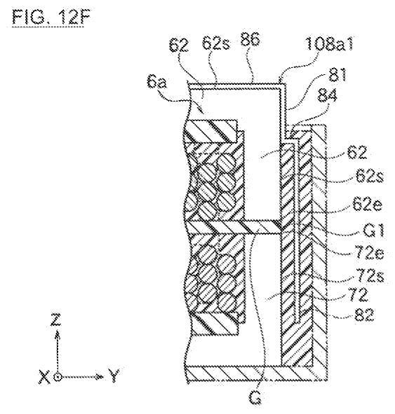

The present invention is not limited to the above-mentioned embodiments and can variously be modified within the scope of the present invention. For example, as shown in FIG. 12A, the extremity portion 80e of the side portion 80 of the heat-dissipating plate 8a1 may be located, relative to the Z-axis direction, between the extremity portion 62e of the outer leg portion 62 and the extremity portion 72e of the outer leg portion 72. That is, the extremity portion 80e may be disposed within the range of the gap side portion G1. The same applies to the heat-dissipating plates 8a2, 8b1, and 8b2. The side portion 80 covers the side surface 62s and the gap side portion G1 so that the gap side portion G1 is partly free. Provided that L6 denotes the length along the Z-axis between the extremity portion 62e of the outer leg portion 62 and the extremity portion 80e of the side portion 80 and that L1 denotes the length of the gap G along the Z-axis, L6<L1 is satisfied. However, L6≤L1/2 or L6≤L1/5 may be satisfied. Alternatively, L6≥L1/8, L6≥L1/5, or L6≥L1/2 may be satisfied.

In the present modified example, effects similar to those of the first embodiment can be attained as well. Additionally, in the present modified example, the gap side portion G1 is not entirely blocked with the side portion 80 due to attachment of the heat-dissipating plate 8a1. Thus, over the gap side portion G1, a magnetic field generated at the gap side portion G1 does not readily influence the side portion 80 to prevent generation of an eddy current at the side portion 80 to enable reduction of loss of the coil device 1.

As shown in FIG. 12B, the extremity portion 80e of the side portion 80 may be located at the same level as the extremity portion 62e of the outer leg portion 62. The same applies to the heat-dissipating plates 8a2, 8b1, and 8b2. In this situation, the side portion 80 can cover the side surface 62s of the outer leg portion 62 more widely than in the first embodiment. Thus, heat of the first core 6a is readily transferred to the heat-dissipating plate 8a1, and the heat-dissipation ability of the coil device 1 can be improved.

As shown in FIG. 12C, the side portion 80 may be omitted from the heat-dissipating plate 8a1. Also, as shown in FIG. 12D, the top panel portion 86 may be omitted from the heat-dissipating plate 8a1. The same applies to the heat-dissipating plates 8a2, 8b1, and 8b2. In this situation, the gap side portion G1 is not entirely blocked with the heat-dissipating plate 8a1 due to its attachment, and influence of a magnetic field generated at the gap side portion G1 on the heat-dissipating plate 8a1 can be prevented as well.

As shown in FIG. 12E, the step portion 84 of the heat-dissipating plate 108a1 may extend in a direction orthogonal to the first portion 81 at the same level as the extremity portion 62e of the outer leg portion 62. Also, as shown in FIG. 12F, the step portion 84 of the heat-dissipating plate 108a1 may extend in a direction orthogonal to the first portion 81 at a level closer to the top surface 61s than a center of the outer leg portion 62 in the Z-axis direction (or a center of the first core 6a in the Z-axis direction). In this situation, the gap side portion G1 is not blocked with the second portion 82 due to attachment of the heat-dissipating plate 108a1, and influence of a magnetic field generated at the gap side portion G1 on the second portion 82 can be prevented as well. According to experiments by the present inventors and the like, it is confirmed that the modified example shown in FIG. 12F has a larger effect of reducing loss than the modified example shown in FIG. 12E.

The structures shown in FIGS. 12A to 12D may be applied to the heat-dissipating plates 9a1 and 9a2 of the fourth embodiment.

In the first embodiment, the side portion 80 of the heat-dissipating plate 8a1 shown in FIG. 4 may abut neither the side surface 62s, the gap side portion G1, nor the side surface 72s. The same applies to the heat-dissipating plates 8a2, 8b1, and 8b2. In this situation, the gap side portion G1 is not blocked with the side portion 80 due to attachment of the heat-dissipating plate 8a1, and influence of a magnetic field generated at the gap side portion G1 on the side portion 80 can be prevented as well.

In the first embodiment, the heat-dissipating plates 8a1 and 8a2 are separately provided as shown in FIG. 2; however, they may be integrally provided. Similarly, the heat-dissipating plates 8b1 and 8b2 are separately provided; however, they may be integrally provided. The heat-dissipating plates 8a1 and 8b1 are separately provided; however, they may be integrally provided. The heat-dissipating plates 8a2 and 8b2 are separately provided; however, they may be integrally provided. The same applies to the second embodiment to the fourth embodiment. The same applies to the heat-dissipating plates 9a1 and 9a2 (FIG. 11) of the fourth embodiment.

In the first embodiment, the first cores 6a and 6b and the second cores 7a and 7b are E-shaped cores as shown in FIG. 2; however, shapes of these cores are not limited. For example, the first cores 6a and 6b may be E-shaped cores (or I-shaped cores), and the second cores 7a and 7b may be I-shaped cores. Alternatively, the second cores 7a and 7b may be E-shaped cores (or I-shaped cores), and the first cores 6a and 6b may be I-shaped cores. The same applies to the second embodiment to the fourth embodiment.

In the first embodiment, the side portion 80 and the top panel portion 86 of the heat-dissipating plate 8a1 (the same applies to the heat-dissipating plates 8a2, 8b1, and 8b2) are integrally provided as shown in FIG. 4; however, the side portion 80 and the top panel portion 86 may be separate. The same applies to the second embodiment to the fourth embodiment. The same applies to the heat-dissipating plates 9a1 and 9a2 (FIG. 11) of the fourth embodiment.

In the above embodiments, an example of application of the present invention to a transformer has been described; however, the present invention may be applied to coil devices other than transformers.

### REFERENCE NUMERALS

1, 101, 201, 301 . . . coil device
2 . . . bobbin
20 . . . tubular portion
21 to 23 . . . flange portion
24a, 24b . . . terminal block
25 . . . wall portion
26_1, 26_2 . . . side wall portion
27 . . . partition portion
28_1, 28_2 . . . columnar portion
29 . . . bottom portion
30_1, 30_2 . . . lead-out path
31 . . . flange extending portion
32 . . . protruding portion
33_1, 33_2 . . . groove
34a, 34b . . . locating portion
4 . . . first coil
40 . . . wire
41 . . . winding portion
42, 43 . . . lead-out portion
5 . . . second coil
50 . . . wire
51 . . . winding portion
52, 53 . . . lead-out portion
6a, 6b . . . first core
61 . . . base portion
61s . . . top surface
62 . . . outer leg portion
62s . . . side surface
62e . . . extremity portion
63 . . . middle leg portion
7a, 7b . . . second core
71 . . . base portion
71s . . . top surface
72 . . . outer leg portion
72s . . . side surface
72e . . . extremity portion
73 . . . middle leg portion
8a1, 8a2, 8b1, 8b2, 108a1, 108a2, 108b1, 108b2, 208a1, 208a2, 208b1, 208b2 . . . heat-dissipating plate
80, 180, 280 . . . side portion
80e . . . extremity portion
81 . . . first portion
82 . . . second portion
82e . . . extremity portion
83 . . . third portion
84, 85 . . . step portion
86 . . . top panel portion
9a1, 9a2 . . . heat-dissipating plate
90 . . . side portion
96 . . . top panel portion
10a to 10d . . . terminal
11 . . . wire joint portion
12 . . . connecting portion
13 . . . middle portion
14 . . . case
14s . . . side portion
14b . . . bottom portion
15 . . . heat-dissipating resin
G . . . gap
G1 . . . gap side portion
S . . . space

What is claimed is:

1. A coil device comprising:
a coil;
a bobbin provided with the coil;
a first core and a second core attached to the bobbin so as to face each other; and
a first heat-dissipating plate attached to the first core,
wherein
the first core comprises a first base portion and a first outer leg portion protruding from the first base portion and facing the second core with a gap therebetween;
the gap has a gap side portion between a first side surface of the first outer leg portion and a second side surface of the second core; and
the first heat-dissipating plate covers at least the first base portion or the first outer leg portion so that the gap side portion is at least partly free.

2. The coil device according to claim 1, wherein
the first heat-dissipating plate comprises a side portion extending along the first side surface; and
the side portion covers the first side surface so that the gap side portion is entirely free.

3. The coil device according to claim 2, wherein the side portion is disposed at a location apart from the gap side portion in an axial direction of the first outer leg portion.

4. The coil device according to claim 1, wherein
the first heat-dissipating plate comprises a side portion extending along the first side surface; and
the side portion covers the first side surface and the gap side portion so that the gap side portion is partly free.

5. The coil device according to claim 2, wherein the side portion is in contact with the first side surface.

6. The coil device according to claim 4, wherein the side portion is in contact with the first side surface.

7. The coil device according to claim 1, wherein
the first heat-dissipating plate comprises a side portion extending along the first side surface;
the side portion comprises a first portion and a second portion closer to the second core than the first portion is; and
the second portion covers the second side surface and the gap side portion so that the gap side portion is at least partly free.

8. The coil device according to claim 7, wherein the first portion and the second portion are connected using a step portion.

9. The coil device according to claim 8, wherein
the first portion is in contact with the first side surface;
the second portion is apart from the gap side portion so that a space is provided between the second portion and the gap side portion; and
the second portion is apart from the second side surface so that a space is provided between the second portion and the second side surface.

10. The coil device according to claim 1, wherein
the first heat-dissipating plate comprises a side portion extending along the first side surface;
the side portion comprises a first portion, a second portion closer to the second core than the first portion is, and a third portion between the first portion and the second portion; and
the third portion covers the gap side portion so that the gap side portion is at least partly free.

11. The coil device according to claim 10, wherein
the first portion and the third portion are connected using a first step portion; and
the second portion and the third portion are connected using a second step portion.

12. The coil device according to claim 11, wherein
the first portion is in contact with the first side surface;
the second portion is in contact with the second side surface; and
the third portion is apart from the gap side portion so that a space is provided between the third portion and the gap side portion.

13. The coil device according to claim 2, wherein the first heat-dissipating plate comprises a top panel portion continuing to the side portion and extending along a top surface of the first base portion.

14. The coil device according to claim 4, wherein the first heat-dissipating plate comprises a top panel portion continuing to the side portion and extending along a top surface of the first base portion.

15. The coil device according to claim 7, wherein the first heat-dissipating plate comprises a top panel portion continuing to the side portion and extending along a top surface of the first base portion.

16. The coil device according to claim 10, wherein the first heat-dissipating plate comprises a top panel portion continuing to the side portion and extending along a top surface of the first base portion.

17. The coil device according to claim 1, wherein
a second heat-dissipating plate is attached to the second core; and
the second heat-dissipating plate covers the second side surface so that the gap side portion is at least partly free.

18. The coil device according to claim 1, wherein the second core comprises a second base portion and a second outer leg portion protruding from the second base portion and facing the first outer leg portion with the gap therebetween.

19. The coil device according to claim 1, wherein the bobbin is accommodated in a case together with the first core having the first heat-dissipating plate attached.

20. The coil device according to claim 19, wherein the case is filled with a heat-dissipating resin so that the first core and the second core are doused with the heat-dissipating resin.
